(19) United States
(12) Patent Application Publication
(10) Pub. No.: US 2021/0342868 A1
(43) Pub. Date: Nov. 4, 2021

(54) SYSTEM FOR IDENTIFYING DIGITAL DEVICES OF RECIPIENTS AT SPECIFIC LOCATIONS

(71) Applicant: Kisimul Holdings Pty Ltd, St Leonards (AU)

(72) Inventor: Adam McNeill, St Leonards (AU)

(21) Appl. No.: 17/172,976

(22) Filed: Feb. 10, 2021

(30) Foreign Application Priority Data
Apr. 30, 2020 (AU) 2020901368

(51) Int. Cl. G06Q 30/02; G06Q 50/02; G06F 16/2457; G06F 16/29; H04L 12/58; G09B 5/02

(52) U.S. Cl. CPC G06Q 30/0205; G06Q 30/0203; G06Q 50/02; G06Q 30/0261; G06F 16/29; H04L 51/20; G09B 5/02; G06F 16/24575

(57) ABSTRACT

A system for identifying digital devices of recipients on farms. The system has a database of information about disclosers including the address of their farms. The system also utilizes a location-based intelligence program adapted to identify digital devices. The system is characterised in that it uses the longitude and latitude of the farm address to identify the digital devices within a certain proximity to that farm address, dispatches messages to any digital device which comes within a certain proximity of the longitude and latitude of the farm address; and the system has a search facility to enable the user of the system to select any farms in the database with certain characteristic information supplied by the discloser.

### TECHNICAL FIELD

The present invention relates to the information technology industry and more particularly to a system for identifying digital devices of recipients at specific locations.

### BACKGROUND

Databases can be compiled about people who have disclosed information about themselves to market research companies. However, disclosing the data from the market research company to third parties may constitute a breach of privacy.

The information obtained by the market research company can be used for the dispatch of relevant messages to those people. However, if the message only has relevance to the person because of their address, then ongoing messages would no longer be relevant to the person once they move address.

A means is required for the devices owned by people in geographic proximity to an address to be identified so that messages can be dispatched to those devices. The digital devices in proximity to the address is not the same information as the data that was originally provided by the discloser to the recipient (i.e. the market research company).

In addition, a means is required for disseminating educational information via mobile devices, particularly in rural areas, where useful messages can be sent to people on the land about that land, irrespective of whether they are the current owners of the land. Anyone can compile a database of farmers, but that data is going to continuously change. A means is required for dynamically and automatically updating the contact details of relevant recipients for farming related information.

Farmers tend to continuously use the practices that they were initially taught. However, if they are seventy years old and they still use practices that they learned 50 years ago, then that knowledge is out of date. The climate changes, so new practices need to be adopted accordingly. In addition, there is a plethora of new technology and materials that are relevant to farming. However, most of these ideas are not adopted or not known by farmers.

One aspect of global pandemics is that food is not distributed internationally as much as did before. Accordingly, each country needs to become more self-sufficient in terms of food production. That requires a greater level of education to maximise productivity.

The object of the present invention is to provide a system to dispatch messages to the digital devices of people at specific locations. Another object of the invention is to lift the general level of education in the farming industry to improve agricultural productivity. Another object of the invention is to improve national food security.

### SUMMARY OF THE INVENTION

According to the present invention, there is provided a system for identifying digital devices of recipients on farms, the system comprising:
(a) a database of information about disclosers including the address of their farms; and
(b) a location based intelligence program adapted to identify digital devices, wherein the system:
   i. uses the longitude and latitude of the farm address to identify the digital devices within a certain proximity to that farm address;
   ii. dispatches messages to any digital device which comes within a certain proximity of the longitude and latitude of the farm address; and
   iii. has a search facility to enable the user of the system to select any farms in the database with certain characteristic information supplied by the discloser.

Preferably, the recipients are selected from a range of longitudes and latitudes within an area outside a particular geographic location. For example, the recipients may be selected from a range of longitude and latitudes within an area 5 kilometres outside a town centre.

Preferably, the database has a search facility which enables the user of the system to select any disclosers which have provided information about a particular farm, its location or other characteristics of the farm. For example, the search facility may enable the identification of a specific farm type such as a grain farm, a beef farm or a sheep farm. The search facility may enable the user to identify farms of a certain size. The search facility may enable the user to identify farms in specific area. The search facility may enable the user to identify farms with commodities (such as grain or milk) having certain price.

The database may include information about the type of farm of the discloser who is to receive the digital message. The database preferably includes a search facility which enables the user of the system to select any disclosers which have provided information about particular characteristics. For example, a user of the system may want to identify all cattle farms of over 1000 hectares in size in the Tamworth area.

The digital message dispatched to the discloser may be an advertisement. The advertisement may be, for example, a banner ad on a news media website, or the broadcast of a video advertisement on a television network. The digital message could also be an automated market research survey for people in a specific location. By way of another example, the market research survey could ask the opinion of residents in a particular electorate of their mayor.

The database may include a dynamic feed of information relevant to the disclosers. For example, the database may include a feed of information about the rainfall in the area of the disclosers. The digital messages dispatched to the disclosers may be an advertisement. For example, the advertisement may be about a fertilizer for farms which have experienced a large amount of rainfall. An advertisement may be relevant for farmers who have not experienced a large amount of rainfall so that they can be made aware of government assistance programs. The dynamic feed may include, for example, the price of commodities, such as grain, which may be relevant to farmers who receive messages as a result of the system. The digital message may be an automated market research survey for people in a specific area.

### BRIEF DESCRIPTION OF DRAWINGS

The invention will be described with reference to the following drawings, in which:

FIG. 1 is depiction a map showing digital devices identified by the system of the present invention within proximity of a designated longitude and latitude.

FIG. 2 is a map showing various digital devices identified by the system of the present invention in a rural area outside the centre of a country town.

### DETAILED DESCRIPTION

The object of the present invention is to provide a system to dispatch educational messages to the digital devices of people at specific locations. Another aspect of the invention is to identify the right digital devices so that the messages are relevant to the recipient.

A market research database is compiled which contains details of relevant customers. In one embodiment of the invention, the database is for farmers located in Australia and New Zealand. The data about the farmers may include the address of their farm, the nature of their farming activities, the size of their farm, the shape of the farm obtained from satellite imagery (which reveals the nature of the farming activities on different parts of the farm), the farmer's approximate income, their approximate output benchmarks, mix of farming (for example, sheep, cattle, and grains, including the type of grains), their level of production (such as the number of dairy cows on the farm), their assets (such the number of their cattle), their agricultural output (including the type of grapes or the number of their vineyards), information about the weed resistance of their crops, information about the amount of harvests they predict (e.g. 3 tonnes per acre), their Australian Business Number, their email addresses, postal address and the longitude and latitude of their address. The database also includes codes relating to the disposition of the farmer, such as whether they are retiring, whether they are interested in particular products, or whether they are selling their farm. The database of the inventors has approximately 120 disposition codes relating to farmers. A database of the present invention has been progressively compiled since 1991 and currently comprises over one billion data points.

The database includes a search query facility that lets the user identify disclosers which have certain characteristics. For example, the user may be interested in cattle farmers on farms over 1000 hectares in size, farms with certain types of activities (such as dairy cow farming, beef farming, or wheat farming), farms with a certain size, or farms in certain postcodes.

A subset of the data is then generated showing those cattle farmers and the longitude and latitude of their street address. This is uploaded directly, via API, to the location—based intelligence platform. As the longitude and latitude of the farm is publicly available information, no breach of privacy can be alleged.

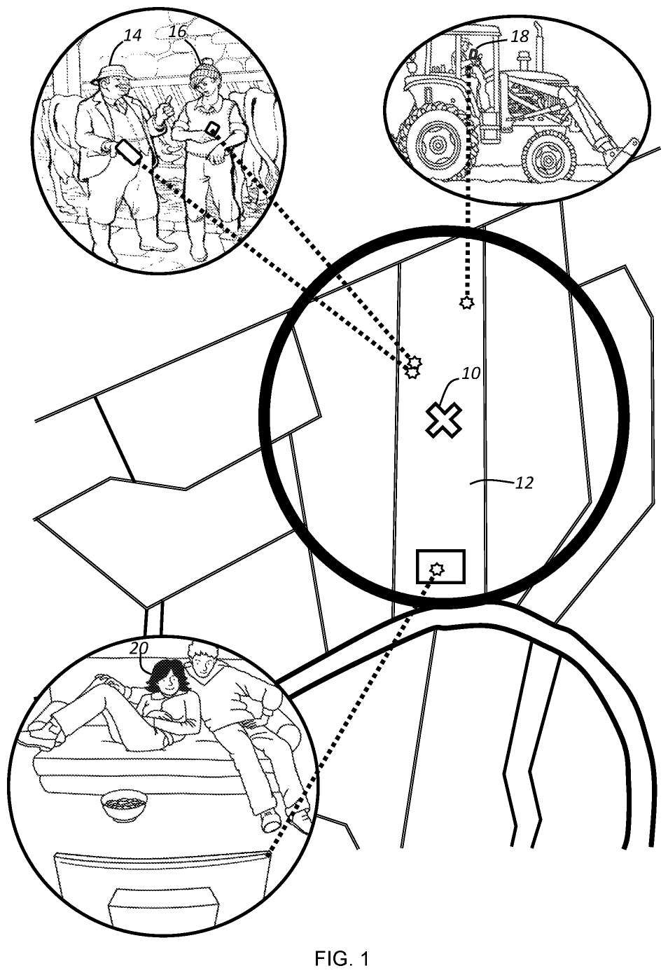

The subset of data can be analysed by a location-based intelligence program that can identify all digital devices within a certain proximity to the longitude and latitude. For example, as shown in FIG. 1, the program can identify all digital devices within a 10 km radius of the longitude and latitude coordinate 10 of the street address of the farm 12. The system may identify the digital devices of not only the farm owner 14, but his farm hand 16, his farm staff 18 and his family 20. This enables a message to be delivered to everyone on the farm and not just the discloser. Moreover, if the farm has been sold and the original discloser no longer lives on the farm, the digital message can still be delivered to anyone on the farm, including the new owners. In this way, old data collected in market research surveys can still be made relevant. This preserves the ongoing value of the database.

The location of the digital devices are determined by a Location Based Intelligence (LBI) service. LBI service compiles information on the identifiers of digital devices. They acquire the identifiers using various means, such as Bid Stream Data, Supply Side Platforms, App Developers, Demand Side Platforms, Data Management Platforms or Internet Service Providers.

Once a location of interest has been identified, a Geofence (i.e. a virtual location boundary) is programmed and set up around the location. Mobile device data is then searched for within the Geofence. Devices are located within the Geofence by triangulation from cellular towers in the area.

The LBI service matches the mobile device identifier to the location and sends the devices identifiers electronically to a programmatic trading platform (such as Google DV360™ or The Trade Desk™). The programmatic bidding and ad serving takes place within the trading platform. The system then places a bid for to send the advertising message on the digital device.

Digital devices can include televisions streaming advertising funded streaming service platforms such as NineNow™ or TenPlay™. In that instance, the system dispatches video messages onto the television of the recipients.

Any connected device using the Internet source within the designated area of the digital device of the recipient can also be dispatched the same advertising message.

Farming is a primary industry, but the farming community is very slow to adopt new technology. This is because most farmers are not continuously connected to computers. As a result, traditional advertising methods for smart farming technology often do not reach their audience. The inventors of the present system have found that most farmers do not read their emails.

The inventors of the present system have found through extensive market research that the most effective form of farmer engagement is via text messages. Many farmers have poor cell phone reception whilst they are in the field. However, if text messages are dispatched to them, upon their return to the homestead and access to a Wi-Fi connection, they receive all the messages sent to them during the day. If those messages involve advertisements for relevant products, then those advertisements are more likely to be effective.

The text messages may involve a link to the website of the operators of the present invention, or directly to their client. The activation of the link can be input into the database of the operators of the present invention. This can trigger the operators to call the farmer to discuss the goods advertised through the system. Once the call is placed, the identify of the farmer can be confirmed and added to the database of the operators of the present invention. This enables the operators to report back to their clients about the effectiveness of the advertising.

Likewise, if those messages involve educational messages regarding farming practices, then that education is more likely to be effective. Every day in the calendar is an ideal day to perform certain farming activities in certain areas. For example, there are ideal days for sheep farmers to perform drenching, shearing and lambing. There are ideal days for sowing and harvesting. There are ideal days to perform weed and pest management. Those days are often dependent on the weather. However, the weather is changing due to climate change. Many farmers do not understand the effects of climate change on their farming practices. There is a need for the mass dissemination of educational information relevant to specific areas at specific times.

As shown in FIG. 1, the family 20 are watching a television. Many smart televisions now have the ability to stream data from individual television networks. Those television networks provide access to television shows and are funded by advertisements. The digital message of the present invention can be delivered through such advertisements, directly targeting products for specific geographic locations. For example, farmers can receive an advertisement for a particular herbicide for a particular weed outbreak in their area. Advertisements for irrelevant products are boring, but advertisements for relevant products are engaging.

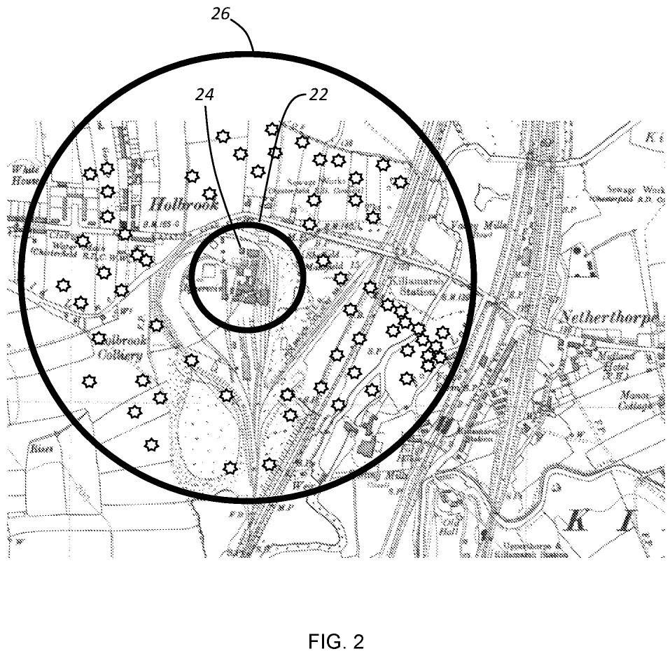

As shown in FIG. 2, only certain longitudes and latitudes may be relevant in a query of the database. In particular, if the goal of the query is to identify farmers in rural areas, then area around the centre of a country town can be ignored when analysing data. Therefore, any digital devices within the town centre are excluded. This can be accomplished by excluding a radial area 22 of say five kilometres around the town post office 24 to include a radial area 26 of twenty kilometres.

The device identifier of each digital device is tracked, so that its coordinates can be revealed. A device identifier is a distinctive number associated with a digital device. Device identifiers are separate from hardware serial numbers. Types of device identifiers include an Android ID, an Identifier for Advertisers (IDFA) which is a random device identifier assigned by Apple to a user's device, a Universal Device ID, a Unique Device ID (UDID) and a Media Access Control address. If the device identifier falls within the geographic area defined by the current system, then it is listed for receipt of a message from the system of the present invention.

Email addresses of individuals can be used to identify persons of interest. However, it is difficult to obtain these email addresses. The email addresses could change over time. Moreover, a farmer may sell a farm, in which case his email address is no longer relevant. By contrast, using the longitude and latitude of the farm means that any subsequent owner or any person who attends the farm, will receive a relevant message from the system of the present invention.

Acquiring a database of email addresses from a third party may constitute a breach of privacy. Using the email addresses without the consent of their owners may also constitute a breach of privacy. Furthermore, using email addresses will not identify third parties that are in the relevant location, that is, on the farm. For example, the system of the present invention will identify all digital devices in the relevant area of the farm, such as the farm hand, the farmer's partner and any friends, family or visitors to the farm. Influencing discussions between relevant people on the farm who receive the same advertisement may increase sales of products.

Anyone can compile a database of device identifiers, but those identifiers need to be mapped to a specific location using another database in order for relevant messages to be dispatched.

The users of the system can then work with a client to allow them to buy digital media that targets the device identifiers within their chosen segments. The system of the present invention could be used to distribute messages, such as educational messages, advertisements, government messages, market research surveys (including polling). More importantly, the messages can also include educational information.

In the case of farmers, the messages may include details of new farming practices, new technology to increase yields, or new input materials such as fertilizers, herbicides and pesticides.

For example, if you plant seeds at the wrong time, then your seeds will not germinate. The right time to plant seeds varies with the climate, which is now changing every season. Information from agricultural scientists regarding the best time to plant can be disseminated widely amongst the farming community instead, instead of individual farmers gambling on the weather. This information can increase agricultural productivity and thereby food security.

By way of another example, some forms of cattle are more resistant to climate change, but many cattle farmers are committed to the wrong breed that their families have farmed for generations. Many farmers produce the wrong commodities at the wrong time as a result of a lack of education, which can affect food security.

In addition, the messages can include details of autonomous farming robots that can perform activities such as seeding, feeding and weeding.

Messages from agricultural insurance companies can be disseminated using the system of the present invention. The insurance can be made dependent on the farmers adopting a list of best practices which are consistent with the latest agricultural science and practices.

If banks are aware that farmers are being educated and the farms are productive as a result, then those banks are more likely to provide loans to farmers. Many farmers require loans in order to produce the crops from the land, make a return on the investment and pay the loans.

The system of the present invention can be used to ensure that risk is mitigated in real time and farming productivity is maximized.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for identifying digital devices of recipients on farms, the system comprising:
(a) a database of information about disclosers including farm addresses of the disclosers; and
(b) a location based intelligence program adapted to identify digital devices, wherein the system:
i. uses the longitude and latitude of a farm address to identify the digital devices within a certain proximity to the farm address;
ii. dispatches messages to any digital device which comes within a certain proximity of the longitude and latitude of the farm address; and
iii. has a search facility to enable the user of the system to select any farms in the database with certain characteristic information supplied by the discloser.

2. The system of claim 1, wherein the digital message is educational information relevant to the specific location.

3. The system of claim 1, wherein the database includes a dynamic feed of information relevant to the disclosers.

4. The system of claim 1, wherein the digital message is a market research survey.

5. The system of claim 1, wherein the recipients are selected from a range of longitudes and latitudes within an area outside a particular geographic location.
